(19) United States
(12) Patent Application Publication
(10) Pub. No.: US 2012/0276297 A1
(43) Pub. Date: Nov. 1, 2012

(54) SURFACE COATING SYSTEM AND METHOD

(75) Inventors: Christopher C. Cypcar, Racine, WI (US); Josef Jans, Seuzach (CH)

(73) Assignee: DIVERSEY, INC., Sturtevant, WI (US)

(21) Appl. No.: 13/512,085

(22) PCT Filed: Nov. 24, 2010
(86) PCT No.: PCT/US2010/058040

§ 371 Date: Jul. 9, 2012

Related U.S. Application Data
(60) Provisional application No. 61/264,471, filed on Nov. 25, 2009.

(51) Int. Cl. C09D 133/08; B05D 1/36; C09D 127/06; C09D 131/04; C09D 129/04

(52) U.S. Cl. 427/407.1; 524/563; 524/561; 524/590; 524/557; 524/567; 524/565; 523/400

(57) ABSTRACT

Coating systems for a surface (such as a floor) including a peelabie layer composition including a peelabie layer film former, and a maintenance layer composition including a maintenance layer film former having a first Tg from about −100° C. to about 20° C. Methods of coating a surface are also provided. One method may include applying a peelabie layer composition including a peelabie layer film former to form a peelabie layer having a tensile strength that is greater than an adhesive strength, and applying a maintenance layer composition including a maintenance layer film former including a self- crosslinking polyurethane, a polyurethane copolymer, or a combination thereof.

### CROSS-REFERENCE TO RELATED APPLICATIONS

This application claims priority under 35 U.S.C. §119(e) to U. S. Provisional Patent Application No. 61/264,471 filed on Nov. 25, 2009. The contents of this application are hereby incorporated by reference in their entirety.

### INTRODUCTION

Floor care programs today are primarily used to both protect and enhance the appearance of a floor substrate, such as vinyl, linoleum, wood, concrete, marble, terrazzo, ceramic, and the like. These flooring materials are prone to wear and deterioration with traffic, such as pedestrian or vehicular traffic. Sacrificial coatings are often used to protect flooring materials from physical wear, scratching, staining, and chemical damage. These coatings are part of a floor care program which can include many different types of products, but generally involve the use of a base and/or finish applied to the surface of a floor substrate. This finish is then maintained with the use of cleaners and tools, which can include various buffing or burnishing machines. Although these programs are very effective, they are considered a large expense to customers. Additionally, if the surface becomes worn or unsatisfactory over time, it is necessary to entirely remove the floor finish or sealer utilizing various chemical compositions, commonly known as strippers. Such chemical stripping is time-consuming and labor-intensive.

It has also been common to treat many flooring substrates with durable semi-permanent coatings, such as those utilizing urethanes, epoxy, or silane technologies. These coating systems suffer from their lack of chemical removability and repairability, and removal often consists of sanding, mechanical abrasion, or chemical stripping. These are significant limitations and often result in unsatisfactory results.

Polymer-based floor coatings are an example of finishes or coatings that are typically applied with a mop or other applicator as an aqueous emulsion or solvent solution that dries to a hard protective film. The removal of these coatings from floor surfaces has traditionally required the use of corrosive chemical solutions, typically mixtures of alkalis and volatile solvents. Accordingly, recent trends in protective floor coatings are to move away from these traditional finishes and move toward the more durable, highly cross-linked coatings, such as UV-cured urethanes, polyurethane dispersions, and epoxies. These coatings, while they have enhanced durability over more traditional floor finishes, suffer in that they, too, eventually have to be removed from the floor due to scratching, scuffs, etc. However, while more traditional floor finishes can be removed chemically, the highly cross-linked nature of these more durable films makes them difficult, if not impossible, to remove by any means other than physical abrasion.

Additionally, with regard to either chemical or a mechanical abrasive stripping, often times the underlying flooring substrate or surface is damaged, for instance in the case of wood flooring where utilization of chemicals and/or water damage the wood surface.

Significant difficulties and deficiencies exist in repair, remediation or removal of the sacrificial or durable, semi-permanent coatings or finishes. Thus, there is an ongoing search for a surface coating system which would enable a surface to be coated with a finish, which can be quickly and easily applied, yet is readily removable and/or repairable after damage or wear.

In summary, a considerable number of deficiencies exist in the art relating to coating systems or finishes for surfaces, such as floor surfaces and the like.

### SUMMARY

Among other things a coating system is provided. The coating system may comprise a peelable layer composition comprising a peelable layer film former. The coating system may also comprise a maintenance layer composition comprising a maintenance layer film former. The maintenance layer film former may have a first T_{g} from about −100° C. to about 20° C.

In another aspect, a method of coating a surface is provided. The method may comprise applying a peelable layer composition comprising a peelable layer film former to form a peelable layer. The peelable layer may have a tensile strength that is greater than an adhesive strength. The method may also comprise applying a maintenance layer composition comprising a maintenance layer film former. The maintenance layer film former may comprise a self-crosslinking polyurethane, a polyurethane copolymer, or a combination thereof.

In another aspect, method of coating a surface is provided. The method may comprise applying a peelable layer composition comprising a peelable layer film former. The method may also comprise and applying a maintenance layer composition comprising a maintenance layer film former. The maintenance layer film former may have a first T_{g} from about −100° C. to about 20° C.

In another aspect, a coating system is provided. The coating system may comprise a peelable layer composition for forming a peelable layer. The peelable layer composition may comprise a peelable layer film former. The peelable layer may have a tensile strength that is greater than an adhesive strength. The coating system may also comprise a maintenance layer composition comprising a maintenance layer film former. The maintenance layer composition may comprise a self-crosslinking polyurethane, a polyurethane copolymer, or a combination thereof.

Other aspects of the invention will become apparent by consideration of the detailed description and accompanying drawings.

### BRIEF DESCRIPTION OF THE DRAWINGS

FIG. 1A shows a cross-section of a surface coating system applied to a floor surface;

FIG. 1B shows a cross-section of a multi-layered surface coating system applied to a floor surface;

FIG. 2 shows a cross-section of the surface coating system of FIG. 1A, where the maintenance layer is being peeled away from the base layer; and

FIG. 3A shows a cross-section of a surface coating system in which a starter mechanism is placed underneath a peelable layer to assist with peeling the peelable layer and the maintenance layer away from the base layer.

FIG. 3B shows a cross-section of a surface coating system in which a starter mechanism is placed adjacent a wall, where the starter mechanism is only partially covered by the peelable and maintenance layers;

FIG. 4 shows a cross-section of a surface coating system in which multiple starter mechanisms are disposed between the peelable layer and the base layer;

FIG. 5 shows a perspective view of a room in which the surface coating system, including a series of starter mechanisms, has been applied; the inset showing a cross-section of the flooring system at a location indicated by the circle;

FIG. 6 shows a cross-section of a surface coating system in which a base layer has only been applied in the region of a joint in the flooring substrate;

FIG. 7 shows a cross-section of a multi-layered surface coating system applied to a floor surface, including a series of starter mechanisms in each layer, wherein the starter mechanisms are staggered between layers;

FIG. 8 shows a cross-section of a surface coating system in which a starter mechanism has been applied in the region of a joint in the flooring substrate;

FIG. 9 shows a cross-section of a multi-layered surface-coating system that has been applied to sections of installable flooring material, including starter mechanisms applied at the edges of the installable flooring material in each coating of the peelable layer; and

FIG. 10 shows a cross-section of a surface coating system in which a piece of a starter mechanism is exposed above the surface of the topmost layer of layer.

### DETAILED DESCRIPTION

The present disclosure is not limited in its disclosure to the specific details of construction, arrangement of components, or method steps set forth herein, The compositions and methods disclosed herein are capable of being made, practiced, used, carried out and/or formed in various ways. The phraseology and terminology used herein is for the purpose of description only and should not be regarded as limiting. Ordinal indicators, such as first, second, and third, as used in the description and the claims to refer to various structures or method steps, are not meant to be construed to indicate any specific structures or steps, or any particular order or configuration to such structures or steps. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification, and no structures shown in the drawings, should be construed as indicating that any non-claimed element is essential to the practice of the invention. The use herein of the terms “including,” “comprising,” or “having,” and variations thereof, is meant to encompass the items listed thereafter and equivalents thereof, as well as additional items. Unless specified or limited otherwise, the terms “mounted,” “connected,” “supported,” and “coupled” and variations thereof encompass both direct and indirect mountings, connections, supports, and couplings. Further, “connected” and “coupled” are not restricted to physical or mechanical connections or couplings.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure. Use of the word “about” to describe a particular recited amount or range of amounts is meant to indicate that values very near to the recited amount are included in that amount, such as values that could or naturally would be accounted for due to manufacturing tolerances, instrument and human error in forming measurements, and the like.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinency of any of the documents cited herein. All references cited herein are fully incorporated by reference, unless explicitly indicated otherwise. The present disclosure shall control in the event there are any disparities.

The present invention has potential applications on any surface where protection, scuff resistance, or slip resistance is desirable. Such surfaces include floors, food preparation surfaces, walls, etc. The surfaces to be finished may be made from a large variety of materials, including, but not limited to, engineered stone, engineered wood, vinyl, marble, terrazzo, ceramic, linoleum, wood, metal, plastic, rubber, concrete, stone, vinyl composition tiles (VCT) and glass.

The present invention relates to a coating system including a peelable layer composition and a maintenance layer composition. The coating system optionally includes a base layer composition and/or a transition layer composition. In addition, the coating system optionally includes a removal tool and or instructions for use. The peelable layer has a tensile strength that is greater than its adhesive strength to the surface or to the optional base layer, if present. This allows the peelable layer to be non-chemically removed from the surface with minimal to no damage to the surface. Other peelable layer composition systems, such as those disclosed in WO2008/144535, incorporated herein by reference in its entirety, are known.

The optional removal tool may be a razor blade or the like or it may be a tool such as that described in U.S. Application No. 61/023,351 filed Jan. 24, 2008, which is incorporated by reference herein in its entirety. One of ordinary skill in the art would be able to determine suitable removal tool for use in the invention.

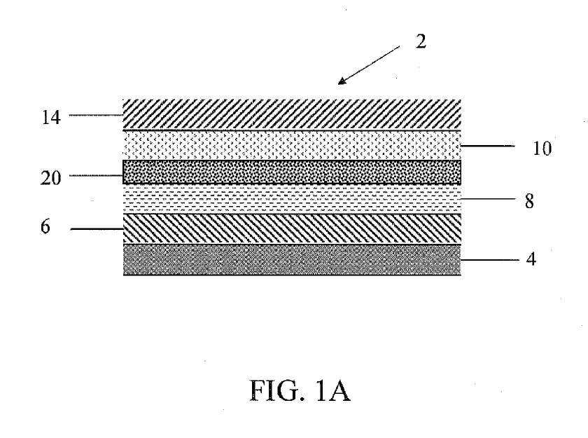

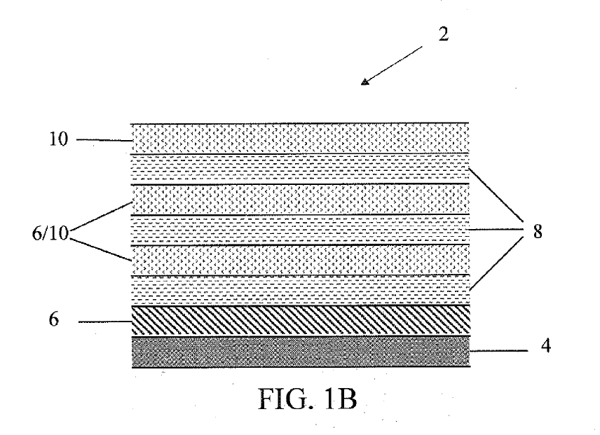

FIG. 1A shows an exemplary embodiment of a surface coating system 2 applied to a surface 4 such as a floor. The surface coating system 2 includes a peelable layer 8 disposed on top of a base layer 6. The coating system 2 further includes a maintenance layer 10 disposed on top of the peelable layer 8. Depending at least in part upon the type of material coated by the surface coating system, the surface coating system 2 need not necessarily include the base layer 6. Where used, the base layer 6 is designed to remain adhered to the surface 4 to be finished. The peelable layer 8, optional transition layer 20, and maintenance layer 10 are designed to remain adhered to one another, yet peel away from the base layer 6 or surface 4 to enable stripping and refinishing of the surface 4 with minimal to no damage to the surface.

The peelable layer 8 and the peelable layer composition each includes at least one peelable layer film former. Suitable peelable layer film formers include, but not limited to, polyacrylate polymers, polyacrylic polymers, epoxy polymers, polystyrene polymers, polyacrylate-styrene copolymer, polyesters, fluoropolymers, polyvinyl chloride, polyvinyl chloride co-vinyl acetate, polyvinyl alcohol, vinyl acetate polymers, vinyl acetate ethylene copolymers, vinyl acetate acrylate copolymers, polyvinylbutyral, styrene-butadiene copolymers, acrylonitrile-butadiene copolymers, and the like. Other suitable film formers are known to those skilled in the art. In some embodiments, a blend of more than one film former is used

Suitable film formers have been found to provide a balance of flexibility, tensile strength, and adhesion, and include those of the vinyl acetate acrylate copolymers and vinyl acetate ethylene copolymers. Suitable vinyl acetate acrylate copolymers include vinyl acetate-butyl acrylate-methyl methacrylate copolymers. In some embodiments, the solids are present in an amount of about 20 to about 100 wt %, about 30 to about 99 wt %, about 40 to about 98 wt %, about 50 to about 97 wt %, about 60 to about 96 wt %, about 65 to about 95 wt %, and about 70 to about 85 wt %. In some embodiments, the film formers can have a solids level of at least about 10 wt %, at least about 20 wt %, at least about 30 wt %, at least about 40 wt %, at least about 50 wt %, at least about 60 wt %, at least about 65 wt %, and at least about 70 wt %. In other embodiments, the film formers can have a solids level of no more than about 99 wt %, no more than about 98 wt %, no more than about 97 wt %, no more than about 96 wt %, no more than about 95 wt %, or no more than about 85 wt %.

In some embodiments, suitable peelable layer film formers include those that have a glass transition value (T_{g}) of from about −20° to about 60° C., and suitably from about −10° C. to about 50° C. In other embodiments, the T_{g} is from about 0° C. to about 50° C. or 10° C. to about 30° C. For example, the T_{g} may be less than about 60° C., less than about 50° C., less than about 40° C., or less than about 30° C. The T_{g} may be greater than about −20° C., greater than about −10° C., greater than about 0° C., or greater than about 10° C. In those embodiments in which a blend of peelable layer film formers is used, each film former may have a different T_{g}. In general, compositions having higher glass transition values require longer drying times due to higher coalescent/plasticizer demand. In some embodiments, the T_{g} is about 15° C. to about 25° C. or about 20° C.

Film formers can be formulated to provide coatings with rheology properties such that a smooth coating can be applied to the surface. In some embodiments, the peelable layer has a tensile strength at break of at least about 100 pounds per square inch (“psi”), at least about 200 psi, at least about 300 psi, at least about 400 psi, and at least about 500 psi. In some embodiments, the tensile strength of the peelable layer by itself is less than about 3,000 psi, less than about 2,000 psi, less than about 1,000 psi, less than about 800 psi, and less than about 600 psi. In some embodiments, the tensile strength of the peelable layer by itself is between about 100 and about 3,000 psi, about 200 and about 2,000 psi, about 300 and about 1,000 psi, about 400 and about 800 psi, and about 500 and about 600 psi. In some embodiments, the elongation at break of the peelable layer by itself is at least about 50%, in other embodiments the elongation at break of the peelable layer is at least about 100%, or at least about 150%, or at least about 200%, or at least about 250%. In some embodiments, the elongation at break of the peelable layer is less than about 350%, or less than about 300%, or less than about 250%, or less than about 200%. In some embodiments, the elongation at break of the peelable layer is about 100% to about 350%, about 150% to about 300%, and about 200% to about 250%. The elongation may decrease once the peelable layer is top coated.

In some embodiments, the peelable layer composition and the maintenance layer composition form a coating, the coating having a tensile strength of at least about 100 pounds per square inch (“psi”), at least about 200 psi, at least about 300 psi, at least about 400 psi, and at least about 500 psi. In some embodiments, the tensile strength of the coating may be less than about 3,000 psi, less than about 2,750 psi, less than about 2,500 psi, less than about 2,250 psi, and less than about 2,000 psi. In some embodiments, the tensile strength of the coating is between about 100 and about 3,000 psi, about 200 and about 2,500 psi, about 300 and about 2,250 psi, about 400 and about 2,125 psi, and about 500 and about 2,000 psi.

Suitable formulations for the peelable layer composition can have a solids level of about 10 to about 100 wt %, the solids primarily comprising one or more film formers such as those listed above. In some embodiments, the solids can be present in at least about 10 wt % or at least 25 wt % or at least about 50 wt % or at least about 75 wt % of the peelable layer composition. In other embodiments, the solids level is no more than about, 85 wt % or no more than about 75 wt % or no more than about 50 wt % of the peelable layer composition. This includes ranges of about 10 wt % to about 85 wt %, about 25 wt % to about 75 wt %, and about 25 wt % to about 50 wt %.

In addition, the peelable layer composition can also include additives to enhance performance. For example, the peelable layer composition can include plasticizers familiar to those skilled in the art of aqueous coating formulations. Suitable plasticizers include, but are not limited to, dibutyl phthalate, butyl benzyl phthalate, diisooctyl phthalate, diethylene glycol dibenzoate, triethylene glycol dibenzoate, dipropylene glycol dibenzoate, tributoxy ethylphosphate and many other plasticizers known to those skilled in the art. In some embodiments, the plasticizer is in the range of up to about 5 wt % or up to about 3 wt % or up to about 1 wt % of the peelable layer composition. In other embodiments, the plasticizer is present in at least about 0.1 wt % or at least about 0.5 wt %. This includes ranges of about 0.1 to about 5 wt % and about 0.5 to about 3 wt %. Some embodiments include plasticizer in the amount of about 0.5 wt %.

The peelable layer composition can include neutralizers to adjust the pH of the coating formulation. For example, ammonia, ammonium hydroxide, amines, hydroxides, silicates, phosphates and other additives known to those skilled in the art can be used to adjust the pH of the system if deemed necessary at a range of up to about 2 wt % or up to 1 wt % or up to about 0.5 wt % of the peelable layer composition. In other embodiments, the neutralizer can be present in an amount of at least about 0.05 wt % or at least about 0.1 wt %. This includes ranges of about 0.05 to about 2 wt % and about 0.1 to about.1 wt %. Alternative embodiments can include about 0.1 wt % neutralizer.

Suitably the pH is greater than about 7, and may be less than about 10. This includes a pH of between about 7 and about 10.

Some embodiments of the peelable layer composition can also include wetting agents such as ethoxylated non-ionic fluorochemicals, other fluorochemicals, alcohol ethoxylates, organo-silicones, or others known to those of skill in the art. These materials can be used from about 10 wt % or up to about 5 wt % or up to about 3 wt % of the peelable layer composition. In other embodiments, the wetting agent can be present in an amount of at least about 0.01 wt % or at least 0.03 wt % or at least 0.05 wt % or at least 1 wt %. This includes ranges of about 0.01 to about 10 wt %, about 0.03 to about 5 wt %, and about 0.05 to about 3 wt %. Some embodiments utilize about 1 wt % wetting agent. Still other embodiments include about 0.03 wt % wetting agent.

The coating compositions can also include defoamers, such as polysiloxane, silicone or acetylene-based defoamers. Further, coalescing agents such as glycol ethers including but not limited to diethylene glycol ethyl ether, ethylene glycol 2-ethylhexyl ether, and dipropylene glycol n-butyl ether, or other suitable solvents can be utilized. The coalescent agent can be present in the amounts described above with respect to the wetting agent. Various preservatives, dyes, pigments, fragrances, such as the Robertet fragrances including Robertet 98M, nanoparticles, and other additives can also be included in some embodiments. Suitable preservatives include PROXEL GXL (1,2-benzisothiazolin-3-one Na-salt (20%)).

The balance of the peelable layer composition may be water.

In some embodiments, additional components that affect the optical properties (“optical components”) of the peelable layers are added to the peelable layer composition in order to reduce the glossiness of the peelable layer 8 and to produce a matte finish (“matte optical components”). A matte finish can improve the appearance of the floor by making defects less noticeable, and can give the floor a more uniform appearance. Also, if the peelable layer 8 has a matte finish, it is less likely to be mistaken for the maintenance layer 10. This can serve to ensure that the entire floor is covered by the peelable layer during application. Suitable matte optical components include, but are not limited to, fumed silica, silica gels, polyethylene, and hollow glass microspheres. These are typically used in a range of 0.5 to 10 wt % of the peelable layer composition. The components that are added to reduce gloss and produce a matte finish can have a different index of refraction than the base layer 6 or surface. Other suitable optical components are known to those skilled in the art.

In some embodiments, the peelable layer compositions can include about 0 to about 60 wt % water, at least about 10 to about 85 wt % peelable layer film former, about 0 to about 5 wt % plasticizer, about 0 to about 2 wt % neutralizer, about 0 to about 2 wt % defoamer, about 0 to about 5 wt % coalescent agents, about 0 to about 5 wt % wetting agents, and other optional additives including fragrances, preservatives, etc. In some embodiments, the viscosity of the peelable layer composition is between about 0 centipoise (”cP“) and about 10,000 cP, about 0 cP and about 1,000 cP, about 0 cP and about 100 cP, about 0 cP and about 50 cP, about 26 cP and about 32 cP, and in some embodiments between about 26 cP and about 29 cP. In some embodiments, the viscosity of the peelable layer composition is at least about 26 cp, at least about 29 cp, and at least about 50 cp. In some embodiments, the viscosity of the peelable layer composition is less than about 10,000 cp, less than about 1,000 cp, and less than about 100 cp.

Suitably, the peelable layer 8 has sufficient tensile strength when dry so that it can be removed from the optional base layer 6, or the underlying surface 4, by peeling in sheets or fragments thereof. Although not required, it is desirable for the peelable layer 8 to have an adhesion profile such that it will not readily peel off the base layer 6 or surface 4 as a result of typical use such as by foot or light equipment traffic. In other words, in some embodiments the peelable layer 8 has an adhesive strength of about 200 psi, a tensile strength of about 300 to about 1200 psi, and an elongation of about 200 to about 450%.

The peelable layer 8 is applied to the surface 4 or to the base layer 6 such that the surface 4 or the base layer 6 is substantially or completely covered by the peelable layer 8. In some embodiments, the peelable layer composition is applied at a rate of about 300 to about 600 sq. ft/gal, where about 50 wt % solids content results in thicknesses of about 1 mil (0.001 inch) to about 5 mil of the dried layer using traditional mop and bucket methods of application or other suitable applicators. The thickness of the peelable layer 8, along with factors such as its tensile strength, should be sufficient to peel away the peelable layer 8 from the surface 4 or the base layer 6. In some embodiments, the peelable layer thickness is at least about 0.5 mil, at least about 1 mil, at least about 1.5 mil, or at least about 2 mil. However some embodiments can include a peelable layer 8 of less than 1 mil depending at least in part upon the types of peelable layer 8 and/or maintenance layer 10 utilized. In other embodiments, the peelable layer thickness is less than about 3 mil or less than about 2 mil. In some embodiments, the peelable layer thickness is about 0.5 mil or less. In general, the more uniform the thickness of the peelable layer 8, the easier it is to peel the peelable layer 8 away from the surface 4 or the base layer 6. Alternatively, several thinner layers of the peelable layer composition can be applied to create a peelable layer of suitable thickness.

The peelable layer 8 provides a film formed in situ at the point of application to the surface 4 or the base layer 6 (if used). Suitably, no structure is imparted to the peelable layer 8 prior to application.

Exemplary peelable layer compositions include:

| Component | Amount (wt %) |
|---|---|
| Film former | 84.0 |
| Defoamer | 0.02 |
| Wetting | 0.02 |
| agent | |
| Neutralizer | 0.1 |
| Water | 15.86 |
| Film former | 75.0 |
| Wetting | 0.02 |
| agent | |
| Neutralizer | 0.1 |
| Water | 24.88 |
| Film former | 84.0 |
| Defoamer | 0.08 |
| Wetting | 0.02 |
| agent | |
| Neutralizer | 0.1 |
| Water | 15.8 |

The surface coating system 2 of the present disclosure further comprises a maintenance layer 10 comprising at least one maintenance layer film former. In some embodiments, the maintenance layer composition is a water-borne composition. A maintenance layer 10 can be applied to the peelable layer 8 to enhance the durability properties of the overall system 2. These properties can include resistance to physical wear, scratching, staining, and chemical damage. The maintenance layer 10 should be compatible with the peelable layer 8 or the optional transition layer 20 such that a defect-free coating system results. Suitable maintenance layer film formers include, but are not limited to, polyurethanes, epoxies, and polyureas. The maintenance layer may comprise self-crosslinking polyurethanes or polyurethane copolymers. Other suitable combinations such as polyurethane/polyester film formers and polyurethane/polyurea film formers are suitable for use with the invention. Other suitable film formers are known to those skilled in the art. In some embodiments, a blend of film formers may be used. For example, combinations such as polyurethane/polyester film formers and polyurethane/polyurea film formers are suitable for use with the invention.

Other additives such as plasticizers, neutralizers, wetting agents, defoamers, coalescing agents, preservatives, dyes, pigments, fragrances, nanoparticles, cross-linking agents such as zinc ammonia carbonate or water dispersible polyisocyanate cross-linkers, and others known to those skilled in the art can be added to the maintenance layer compositions. Additionally, additives that affect the optical properties of the maintenance layer can be added (“optical components”). These components are all described in more detail above with respect to the peelable layer compositions and can be present in the maintenance layer composition in the percentages as described therein. The balance of the maintenance layer composition may be water.

By incorporating certain wetting agents, plasticizers, and/or coalescents (as discussed above) into the peelable layer 8, a maintenance layer 10 can be utilized with reduced or eliminated chances of incurring aesthetically unpleasant film defects such as “hazing”, “cracking”, “blooming”, “crazing”, and many other types of film defects commonly known to those of skill in the art. Without wishing to be limited by theory, it is believed that adding the surfactants, plasticizers, and/or coalescents enables better inter-coat adhesion and film-formation, which inherently reduces the likelihood of such defects.

It has been found that some floor finish compositions which are water-borne polyurethane-based compositions exhibit the necessary compatibility and durability properties required for the maintenance layer 10. In general, water-borne polyurethane-based compositions include polyurethane or polyurethane forming components, including but not limited to self-crosslinking polyurethanes or polyurethane copolymers. Suitable maintenance layer compositions include commercially available floor finish materials such as Jonwood One Water Based Wood floor finish from Diversey Inc. of Sturtevant, Wis., Bona TRAFFIC and Bona MEGA waterborne finishes from Bona Kemi of Sweden. Suitable maintenance layer compositions also include commercially available film formers such as BAYHYDROL XP 2593/1 and BAYHYDROL XP 2557 and BAYHYDROL XP 2637 available from Bayer Material Science of Pittsburg, Pa. and film formers such as TURBOSET 2025 Polyurethane Dispersion from Lubrizol Corp. of Wickliffe, Ohio and film formers such as NeoReZ 2180 Polyurethane Dispersion and NeoCryl 9045 Polyurethane Dispersion from NeoResins, The Netherlands.

In some embodiments, the maintenance layer film former may have a T_{g} of about −100° C. to about 20° C., suitably about −90° C. to about 30° C., or about −50° C. to about −20° C. For example, the T_{g} of the maintenance layer may be less than about −20° C., less than about −50° C., less than about −60° C., or less than about −80° C. The T_{g} may be greater than about 0° C., greater than about 20° C., greater than about 40° C., or greater than about 60° C. In those embodiments in which a blend of maintenance layer film farmers is used, each film former may have a different T_{g}. For these embodiments, one maintenance layer film former may have a first T_{g} from about −100° C. to about 20° C., and a second maintenance layer film former may have a T_{g} from about −20° C. to about 120° C. Some embodiments may have one maintenance film former with a first T_{g} from about −50° C. to about −20° C., and a second maintenance layer film former with a T_{g} from about 40° C. to about 100° C. In some embodiments, one maintenance layer film former may have a T₉ may be from about −40° C. to about −20° C., and a second maintenance layer film former may have a T_{g} may be from about 70° C. to about 100° C.

The maintenance layer composition can have a solids content of about 15 to about 50 wt % solids. This includes embodiments having a solids content of about 15 to about 25 wt %, which is suitable in some applications. The maintenance layer composition can be applied to provide about a 1 mil wet coating thickness. The thickness may be at least about 0.1 mil, at least about 0.2 mil, at least about 0.5 mil, at least about 1 mil, at least about 1.5 mil and at least about 2 mil. The thickness may be less than about 4 mil, less than about 3.5 mil, less than about 3 mil, less than about 2.5 mil, less than about 2 mil, and less than about 1.5 mil. In some exemplary embodiments, the maintenance layer composition has a solids content of about 20 wt % and produces a hardened dried maintenance layer with a thickness of about 0.2 mil.

Multiple layers of the maintenance layer composition can be applied to completely cover the peelable layer 8, resulting in a maintenance layer with a total thickness of about 0.6 mil to about 4 mil in some embodiments. This total thickness may be at least about 0.1 mil, at least about 0.2 mil, at least about 0.5 mil, at least about 1 mil, at least about 1.5 mil, at least about 2 mil, at least about 2.5 mil, at least about 3.0 mil, and at least about 3.5 mil. The total thickness may be less than about 6.0 mil, less than about 5.5 mil, less than about 5.0 mil, less than about 4.5 mil, and less than about 4.0 mil. One to ten or more coats of the maintenance layer composition 10 can be applied, in some embodiments. Some embodiments of the surface coating system 2 can include four to six layers of maintenance layer 10. The maintenance layer(s) and can also be scrubbed and recoated over time as needed, further increasing their thickness. More than one different maintenance layer 10 may be used.

The adhesion of the maintenance layer 10 to the peelable layer 8 or to the optional transition layer 20 is such that the layers remain adhered to each other when the layers are physically peeled from the base layer 6. In practice, the base layer 6 remains on the top surface 4 of the substrate after the maintenance layer 10, optional transition layer 20, and peelable layer 8 are removed.

Exemplary maintenance layer compositions include:

| Amount (wt %) | Component |
|---|---|
| 16.7 wt % | D.I. Water |
| 4.0 wt % | DOWANOL DPnB - solvent (Dow Chemical, |
| | Midland, MI) |
| 0.2 wt % | FOAMEX 822 - defoamer (Tego Chemie, Hopewell, |
| | VA) |
| 0.90 wt % | SOLSPERSE 40K - flow aid (Lubrizol Corp., |
| | Wickliffe, OH) |
| 0.1 wt % | BYK 307 - flow and leveling aid (Byk Chemie) |
| 78.0 wt % | TURBOSET 2025 - polyurethane dispersion (Lubrizol) |
| 36.1 wt % | D.I. Water |
| 55 wt % | NeoCryl 9045 from DSM NeoResins |
| 8 wt % | DPnB Solvent from Dow |
| 0.3 wt % | Byk 028 Defoamer from Byk Chemie |
| 0.3 wt % | Ammonia neutralizing from Aldrich |
| 0.3 wt % | Surfynol 104DPM wetting aid from Air Products |

The optional transition layer provides a transition between a film former with a lower T_{g} in the peelable layer and a film former with a higher T_{g} in the maintenance layer. If the differences in T_{g} between the film formers in the various layers are too great, the layers will not provide an aesthetically pleasing appearance to the coated surface. The optional transition layer 20 comprises at least one transition layer film former. Suitable transition layer film formers include, but are not limited to, polyacrylates, styrene-acrylic polymers, polyurethanes, epoxies, and polyureas. In some embodiments, a blend of film formers may be used. Other suitable film formers are known to those skilled in the art. Additional components may also be added to the transition layer composition, such as plasticizers, neutralizers, wetting agents, defoamers, coalescing agents, preservatives, dyes, pigments, fragrances, nanoparticles and optical components. These components are all discussed in greater detail above with respect to the peelable layer compositions and can be present in percentages as described therein. The balance of the optional transition layer composition may be water. Suitable transition layer compositions include commercially available floor finish materials such as GEMSTAR LASER and GEMSTAR POLARIS and TAJ MAHAL and FIRST BASE available from Ecolab, Inc. of St. Paul, Minn., BETCO BEST and BETCO EXPRESS and BETCO FLOOR SEALER floor finish from Betco Corp. of Toledo, Ohio, CITATION and CASTLEGUARD floor finish available from Buckeye International of Maryland Heights, Mo., and IRONSTONE and PLAZA PLUS and PREMIA and HIGH NOON and FRESCOMAX and OVER & UNDER from Diversey, Inc. of Sturtevant, Wis.

In some embodiments, the transition layer composition can be the same as the base layer composition or the maintenance layer compositions. In some embodiments the T_{g} of the transition layer film former may be at least about 10° C., at least about 20° C., at least about 30° C., at least about 40° C. and at least about 50° C. The T_{g}, may be less than about 110° C., less than about 100° C., less than about 90° C., less than about 80° C., less than about 70° C. and less than about 60° C. This includes ranges of from about 20° C. to about 100° C. In other embodiments, the T_{g} is from about 50° C. to about 60° C. In those embodiments in which a blend of transition layer film formers is used, each film former may have a different T_{g}.

The transition layer composition can be applied to provide a wet thickness of from about 0.5 to about 4 mil. This thickness may be at least about 0.1 mil, at least about 0.2 mil, at least about 0.5 mil, at least about 1 mil, at least about 1.5 mil, at least about 2 mil, at least about 2.5 mil, at least about 3.0 mil, and at least about 3.5 mil. The thickness may be less than about 6.0 mil, less than about 5.5 mil, less than about 5.0 mil, less than about 4.5 mil, and less than about 4.0 mil. For example, in some embodiments the wet thickness is about 1.0 mil. Suitably, the dry finish is about 0.2 mil. Multiple coats of the transition layer 20 may be applied resulting in a thicker transition layer 20 if desired.

The optional base layer 6 comprises at least one base layer film former. Suitable base layer film formers include, but are not limited to, UV-cured polymers, polyacrylates, polystyrene-acrylate, polyurethanes, epoxies, and polyureas. Other suitable film formers are known to those skilled in the art. The base layer composition may be the same as the maintenance layer composition or the transition layer composition, but this is not required or necessary. In a water-borne polyacrylate or polystyrene-acrylate based composition includes a polyacrylate or polystyrene component including, but not limited to, styrene, methacrylic acid, butyl acrylate, and methacrylate derived monomeric units. In other embodiments, the base layer 6 can also include vinyl-acrylic compounds, although if the peelable layer 8 also comprises a vinyl-acrylic compound, the two layers 6, 8 can have different types of vinyl-acrylic compounds such that the layers 6, 8 are more readily separable at a later time. In some embodiments, a blend of film formers may be used.

Additional components may also be added to the base layer composition such as plasticizers, neutralizers, wetting agents, defoamers, coalescing agents, preservatives, dyes, pigments, fragrances, nanoparticles and optical components. These components are all discussed in greater detail above and can be presented the percentages described therein. The balance of the base layer composition may be water. In some embodiments, the base layer composition is the same as the transition layer, composition and/or the maintenance layer composition.

In some embodiments, the base layer film former has a higher glass transition (T_{g}) temperature than the peelable layer film former. Suitably, the T₉ of the base layer film former is from about −10° C. to about 100° C. In other embodiments, the T₉ is from about 50° C. to about 60° C. In some embodiments, the T₉ of the base layer film former may be at least about −10° C., at least about 0° C., at least about 20° C., at least about 30° C. and at least about 40° C. The T₉ may be less than about 100° C., less than about 90° C., less than about 80° C., less than about 75° C., less than about 70° C. and less than about 65° C. In those embodiments in which a blend of base layer film formers is used, each film former may have a different T_{g}.

In various embodiments, the base layer 6 comprises zinc and zinc-containing compounds. Suitably, the base layer composition contains about 0 to about 5 wt % of a 15% zinc ammonia carbonate solution or about 0 to about 2 wt % ZnO. The base layer 6 is adhered to the upper surface 4 of the substrate such that the base layer 6 cannot be physically peeled off the substrate. Several floor finish compositions commonly available on the market can be utilized as a base layer composition. Examples of suitable commercially-available floor finish materials that can be used as the base layer 6 include GEMSTAR LASER and GEMSTAR POLARIS and TAJ MAHAL and FIRST BASE available from Ecolab, Inc. of St. Paul, Minn., BETCO BEST and BETCO EXPRESS and BETCO FLOOR SEALER floor finish from Betco Corp. of Toledo Ohio, CITATION and CASTLEGUARD floor finish available from Buckeye International of Maryland Heights, Mo., and IRONSTONE and PLAZA PLUS and PREMIA and HIGH NOON and OVER & UNDER and FRESCOMAX from Diversey, Inc. of Sturtevant, Wis.

Suitable base layer compositions can have a solids content of about 15 to about 50 wt %. Some embodiments have a solids content of about 15 to about 25 wt %. The base layer composition can be applied to provide from about 0.5 mil to about 4 mil wet coating thickness. This thickness may be at least about 0.1 mil, at least about 0.2 mil, at least about 0.5 mil, at least about 1 mil, at least about 1.5 mil, at least about 2 mil, at least about 2.5 mil, at least about 3.0 mil, and at least about 3.5 mil. The thickness may be less than about 6.0 mil, less than about 5.5 mil, less than about 5.0 mil, less than about 4.5 mil, and less than about 4.0 mil. For example, in some embodiments of the present invention, the wet coating thickness is about 1 mil. For those embodiments utilizing about 1 mil wet coating thickness and a solids content of about 20 wt %, it is assumed that a hard and dry finish of about 0.2 mil thick base layer is obtained.

Multiple coats of base layer composition can be applied to completely cover the upper surface 4 of the substrate with about 0.6 mil to about 4 mil thick dry finish base layer, in some embodiments. This thickness can be achieved by one application or multiple applications depending at least in part upon the roughness, porosity and/or surface morphology of the upper surface 4 of the substrate.

It is theorized that the base layer 6 provides a surface that is physically and chemically normalized, which is believed to be important for its performance as a base layer 6. Physically normalized means a surface with nearly equal roughness, porosity, and/or surface morphology as that reached by mechanical and/or chemical methods. Chemically normalized means a surface with nearly equal distribution of chemical moieties such as hydroxyl groups, ester groups, hydrocarbon groups, fluorochemical groups, phosphate groups, organo-phosphate groups, metal and metal oxides and the like as that reached by mechanical and/or chemical methods. Suitably, the surface is substantially free of chemical moieties which would either dramatically increase (too much adhesion) or decrease (too little adhesion) adhesion.

In some embodiments, a surface 4 can have appropriate physical and/or chemical properties such that a peelable layer 8 can be directly applied onto the surface 4 in the absence of a base layer 6, while still having the peelable properties described herein. In some embodiments, a peelable layer 8 is applied to a polished concrete floor, and in further embodiments the concrete floor has an epoxy coating thereon which is polished smooth and has the peelable layer 8 applied thereto. The properties of a surface (e.g. the base layer 6 or the upper surface 4 of a substrate) onto which a peelable layer 8 is applied include an adhesive strength that is high enough to prevent the peelable layer 8 from separating during normal use, but low enough to permit peeling of the peelable layer 8 from the base layer 6 (or the surface 4) when removal of the peelable layer 8 is desired. Suitably, the adhesive strength is between about 50 and about 300 psi, or between about 100 and about 200 psi, and more suitably about 180 psi. In some embodiments, the adhesive strength is at least about 50 psi, at least about 100 psi, and at least about 150 psi. In some embodiments, the adhesive strength is less than about 300 psi, less than about 250 psi, and less than about 200 psi.

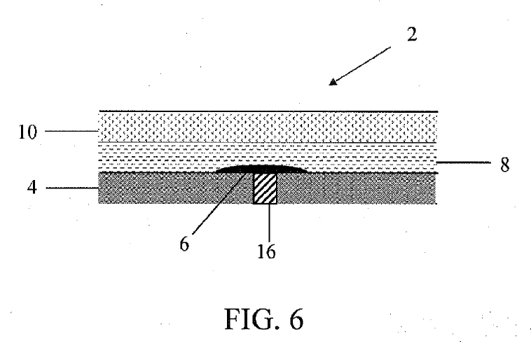

In certain embodiments, such as those in which the peelable layer 8 is applied directly onto the upper surface 4 of a substrate and embodiments in which the base layer 6 has been factory-applied to an installable flooring substrate, it may be desirable to apply a base layer 6 in limited areas to cover joints between sections of the substrate or defects in the substrate 4. For example, if a peelable layer is applied onto a polished terrazzo floor, a base layer 6 can be applied to the joints, which can include metal dividers 16 between sections of the terrazzo floor in order to provide a continuous, smooth surface onto which the peelable layer 8 can be applied (see FIG. 6). Similarly, it may be desirable to cover the joints or seams between sections of tile or between pieces of flooring with base layer 6, even if the upper surface 4 of the tile or flooring has the necessary chemical and/or physical properties to support a direct application of a peelable layer 8.

Additional components that can be added to any of the compositions described and/or illustrated herein include embedded particles, such as abrasives to increase traction and prevent slipping. Suitably, the particles have a. size of about 51 to about 500 microns. Embedded particles can also be added to the base layer composition to provide a slip-resistant surface. Suitably, particles embedded in the base layer 6 are relatively smooth so that the peelable layer 8 and any maintenance layers 10 applied on top of the base layer 6 have continuity and are not abraded during use.

Another component that can be added to any of the compositions described and/or illustrated herein is an optical component such as a reflective particle material that improves the appearance of the floor and can enhance the lighting of a space in which the surface coating system 2 is installed. Suitably, these include glass microspheres or metallized glass microspheres ranging in size from about 1 to about 100 micrometers. Among other advantages, addition of one or more components such as those listed above which change the optical properties of a layer can aid proper application of the coatings, insofar as the added components help in visualizing where the coatings have and have not been already applied. This is especially important in cases in which the coatings form thin, clear layers that can be difficult to distinguish from one another, such that even a difference in finish (e.g. a matte-finish peelable layer 8 being applied on top of a glossy base layer 6) can assist in applying the coatings to determine where the new coating has been applied.

The base layer 6 has a greater adhesion to the upper surface 4 of the substrate than to the peelable layer 8. In some embodiments the adhesion of the maintenance layer 10 applied to the peelable layer 8 or to the optional transition layer 20 is greater than the adhesion of the peelable layer 8 to the base layer 6. Also in some embodiments, the adhesion of the maintenance layer 10 to the peelable layer 8 or to the optional transition layer 20 is sufficiently strong that the maintenance layer 10 and the peelable layer 8 or the optional transition layer 20 are adhered together during the physical removal of the layers. The maintenance layer 10 can confer durability characteristics on the surface coating system 2 such as water resistance, scratch resistance, durability, additional gloss, and stain resistance.

Without wishing to be bound by a particular theory, it is believed that the maintenance layer 10, the peelable layer 8 and the optional transition layer 20 of some embodiments have similar characteristics that allow the layer to form films and not delaminate due to interfacial stress or tension. In such embodiments, the interfacial area, as well as the bulk film, should each have a similar elastic modulus to minimize stress concentration due to modulus mismatch that may result in film cracking or delamination. This modulus should be similar throughout the film formation process and lifetime of the surface coating system. It is also theorized that the maintenance layer 10, the optional transition layer 20 and the peelable layer 8 in some embodiments have similar shrinkage (defined as disruption of the level plane of the finished surface) during film formation of the maintenance layer 10 and throughout the lifetime of the film. The shrinkage in such embodiments should be similar to minimize the loss of gloss, wrinkling, cracking and/or checking of the peelable layer 8, the optional transition layer 20 and the maintenance layer 10.

As shown in FIG. 1A, one or more conventional floor finishes 14 can be applied to the maintenance layer 10, if desired. Conventional floor finishes can include FRESCOMAX floor finish from Diversey, Inc. of Sturtevant, Wis.

In some embodiments, multiple layers of the surface coating system 2 can be applied on top of one another so that the older, top layer can be peeled off at a later time to reveal a fresh wear surface. Each of the multiple layers of the surface coating system 2 includes at least the peelable layer 8 and maintenance layer 10 and can optionally include base layer 6 and transition layer 20. However, if the exposed top surface of the peelable layer 8 is sufficiently smooth and uniform, it may not be necessary to apply a base layer 6 thereon prior to application of an additional peelable layer 8, although adjacent peelable layers 8 can be formulated so that they do not fuse with one another into a single layer.

In some embodiments, a multi-layered peelable surface can be made by alternating successive coatings of peelable layer 8 with the optional transition layer 20 and a maintenance layer 10 allowing one layer to be removed at a time (FIG. 1B).

In practice, prior to finishing or coating a surface 4 with a surface coating system 2 according to any of the embodiments described herein, the surface 4 can initially be cleaned or stripped of any other finish or dirt. Those skilled in the art would readily understand how to accomplish this task. Stripping can be performed using a conventional stripper such as PROSTRIP or FREEDOM from Diversey, Inc. of Sturtevant, Wis., AX-IT or EXTREME from Betco Corp. of Toledo, Ohio, or DA-70 or SQUARE ONE from Spartan Chemical Company of Maumee, Ohio.

After the floor surface 4 has been allowed to dry following stripping, at least one layer of the base layer composition can be applied to the surface 4 if desired. The base layer composition can be applied utilizing a mop and bucket, a T-bar, a roller applicator, or other application device and technique known to those of skill in the art. In some embodiments, such a finish is applied at a coating rate of about 500 to 3,000 square feet per gallon. Still other embodiments apply such a finish composition at a coating rate of about 1,800 to 2,200 square feet per gallon. In some embodiments, this layer of base layer composition is allowed to dry for about 30-45 minutes. Additional base layers can be applied by repeating the above-described steps, if necessary, to create a physically uniform surface. Alternatively, a flooring material which has a physically smooth surface and an appropriate surface energy level may be provided, either by polishing of an existing floor or by installing a flooring material having the requisite properties. Thus, in some embodiments, the peelable layer 8 can be applied directly onto the surface 4 without the prior application of a base layer 6.

After the final coating of base layer composition has been applied and allowed to dry (e.g., for about 30-45 minutes), the peelable layer composition can be applied utilizing a T-bar, mop and bucket, roller, or other applicator at a rate of, for example, about 300 to about 600 square feet per gallon, depending at least in part upon the viscosity of the peelable layer composition. For a composition with a higher viscosity, it may be desirable to use an applicator that rolls on or spreads the composition, such as a T-bar, pad, or roller. In other embodiments, the composition can be sprayed onto the surface, such as by using a compressor-driven power sprayer. The peelable layer 8 can then be allowed to cure or dry to form, in situ on the surface to be finished, resulting in a film having a tensile strength at break of at least about 100 psi.

In some embodiments, the transition layer 20 is applied over the peelable layer 8. The transition layer composition can be applied utilizing a mop and bucket, roller or other suitable application tool and technique. The transition layer 20 can be allowed to cure and dry (e.g. for 30 to 45 minutes in some embodiments). Additional coatings of the transition layer 20 can be applied if desired. In some embodiments from 1 to 3 coatings of the transition layer 20 are applied.

After the peelable layer 8 has cured or allowed to dry (e.g., for approximately 45-120 minutes in some embodiments), the maintenance layer composition can be applied thereover. This maintenance layer composition can be applied utilizing .a mop and bucket, roller, or other suitable application tool and technique. In some embodiments, the maintenance layer composition 10 can be applied at a rate of about 500 to about 3,000 sq ft/gal. This includes embodiments where the coating rate is about 1,800 to about 2,200 sq ft/gal. The maintenance layer 10 can be allowed to cure or dry (e.g., for at least 30-45 minutes, in some embodiments). Additional coatings of the maintenance layer composition can be applied on top of the previous maintenance layers 10. In some embodiments, one to ten coatings of maintenance layer 10 are applied over the peelable layer(s) 8. In some embodiments, four to six coatings of maintenance layer 10 can be applied. Some embodiments consist of one base layer 6, one peelable layer 8, and four maintenance layers 10. Also, in some embodiments, the total thickness of all peelable layers 8 is three to ten times the thickness of a single base layer 6 or maintenance layer 10.

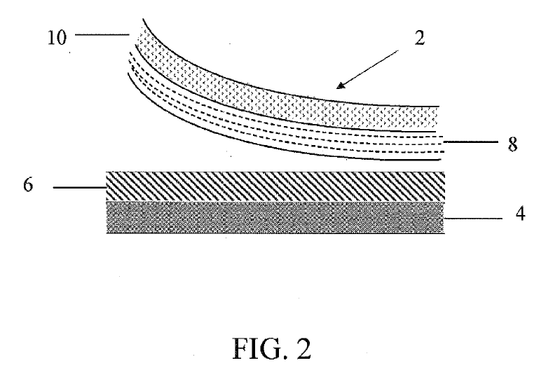

When subsequently addressing the removal of the maintenance layer 10 after it has been damaged, scuffed, dirtied, etc., the need for conventional stripping agents is eliminated. In practice, to remove the maintenance layer 10, which may have become damaged, worn, or dirty over time, one makes a small, inconspicuous cut in the surface of the finish, and grasps, by hand or with a tool, a corner or edge of the peelable layer 8 with the maintenance layer 10 disposed thereon and begins to peel, in sheet form, the peelable layer 8, optional transition layer 20, and maintenance layer 10 away from .the surface 4. The term “sheet” is in no way meant to imply any particular size or dimension. However, in practice, the larger the “sheet” removed, the quicker the overall removal is accomplished. The base layer 6 (if used) remains affixed or adhered to the surface 4 during such removal process, as shown in FIG. 2. As conventional stripping agents are eliminated from the removal process, the removal process can be less expensive, less energy-intensive, and less time-consuming, and also eliminates the need for stripping chemicals.

To accomplish the removal of the peelable layer 8, optional transition layer 20, and maintenance layer 10, a user can manually peel sections or sheets of the peelable layer 8 and maintenance layer 10 together in multiple repeat steps, or can accomplish it in one large sheet. Alternatively, as an example, a tool that scores the layers and includes a roller can be used and run over the floor to more neatly and efficiently remove the layers in uniform sheets. After removal of the layers, a new peelable layer 8 can be applied over the base layer 6 remaining on the surface 4 (or directly upon the surface, in suitable applications as described above). If used, the transition layer 20 is applied thereon. A maintenance layer 10 can then be applied on top of the peelable layer 8 or the transition layer 20 after it has cured or dried. This can be accomplished as previously described in the initial application of the surface coating system 2.

It may be desirable in some cases to repair only a portion of a damaged maintenance layer 10 or surface coating system 2. To accomplish this, the damaged area can be removed using any suitable technique, such as cutting out using a razor blade or other tool suitable for cutting the layers, and peeling only the cut out section away creating an exposed surface. After removal, the peelable layer 8 can be re-applied to an exposed surface (i.e., the area where the section was removed) to form a repaired peelable layer. After the peelable layer 8 dries, the transitional layer is applied if used then a maintenance layer 10 can then be applied to obtain a repaired coating. Due to the polymeric nature of the peelable layer 8, it can re-form one complete film with the original peelable layer 8 around it, such that in some embodiments it can be peeled as part of a larger piece of the already existing layers during subsequent removal.

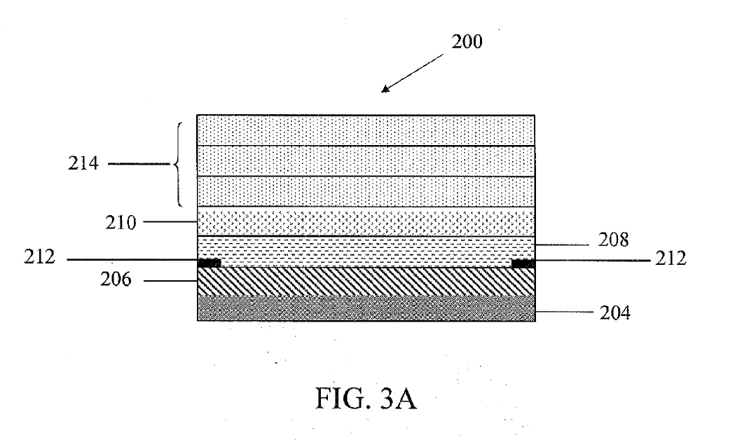

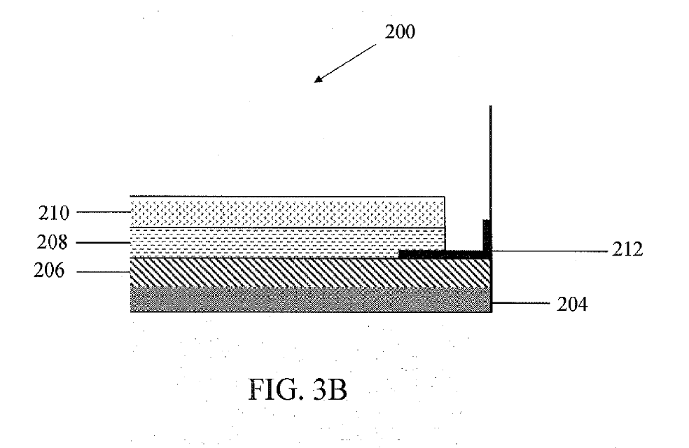

FIGS. 3A, 3B, 4, 5, 7, and 8 illustrate alternate embodiments of the surface coating system 200 according to the present invention. The surface coating systems 200 are similar in many ways to the illustrated embodiments of FIGS. 1A, 1B, 2, and 6 described above. Accordingly, with the exception of mutually inconsistent features and elements between the embodiments of FIGS. 3A, 3B, 4, 5, 7, and 8 and the embodiments of FIGS. 1A, 1B, and 2, reference is hereby made to the description above accompanying the embodiments of FIGS. 1A, 1B, and 2 for a more complete description of the features and elements (and alternatives to the features and elements) of the embodiments of FIGS. 3A, 3B, 4, 5, 7, and 8.

In FIG. 3A, starter mechanisms 212 are shown schematically as they would appear in cross-section, and are located on top of the base layer 206 and beneath or within the peelable layer 208 to facilitate removal of the peelable layer 208 as well as any layers 210 and conventional floor coatings 214 applied thereon. The starter mechanism 212 can have various thicknesses, but in some embodiments is sufficiently thin to minimize any bumps or protrusions in the surface coating system 200. Suitably, the starter mechanism 212 is sufficiently strong so as to resist breaking when pulled through the top layers (i.e. the peelable layer 208, the maintenance layer 210 and, optionally, any conventional floor coating 214 applied on top of the peelable layer 208 and maintenance layer 210).

The starter mechanisms 212 can be strategically placed on a surface in order to facilitate removal of the peelable layer 208 and, where present, the maintenance layer 210 applied thereto. In some embodiments, starter mechanisms 212 are placed on opposite edges of the surface from which the peelable layer 208 is to be removed. For example, if the diagram shown in FIG. 3A represents a cross-section of a hallway, the starter mechanisms 212 could be placed on opposite sides of the hallway against the edges of adjacent walls. Thus, pulling up the starter mechanisms 212 separates the layers from the walls to facilitate complete removal of the layers 210 from the walls. In some variations of this embodiment, the peelable layer 208 and maintenance layer 210 do not completely cover the starter mechanisms 212, but are applied only along the edge of the starter mechanism 212 facing away from the wall. Thus, when the starter mechanism 212 and layers 208, 210 are pulled up, there are no residual layers left on the adjacent wall. In such cases, a wider starter mechanism 212 can be used to allow part of the starter mechanism 212 to be applied along the lower edge of the adjacent wall (FIG. 3B). The starter mechanism 212 can also be applied completely flat, so that its edge is adjacent the wall.

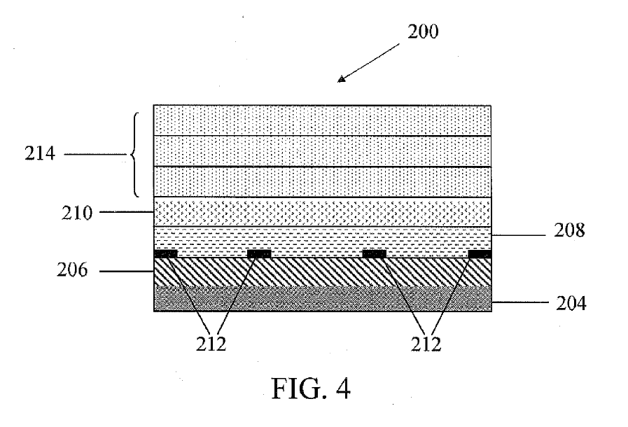

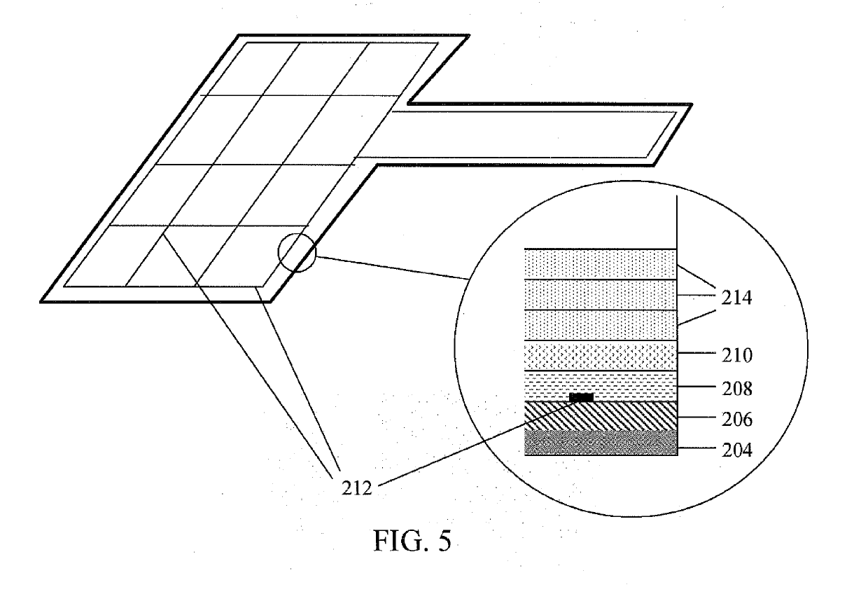

In certain embodiments, the starter mechanisms 212 are applied in a grid pattern, while in other embodiments the starter mechanisms 212 are only applied in parallel side-by-side fashion, In still other embodiments, the starter mechanisms 212 are applied in a pattern that facilitates removal and replacement of the layers in known or anticipated high-traffic areas of a floor, such as in the center of a hallway or in the vicinity of a doorway (see FIGS. 4 and 5).

In some embodiments, the starter mechanism 212 is relatively inconspicuous. For example, the starter mechanism 212 can be clear and colorless, or the starter mechanism 212 can have the same texture and/or color as the surface 204 to which the surface coating system 200 is applied. In other embodiments, the starter mechanism 212 can be selected so as to be readily visible through the layers and, optionally, conventional floor finish coatings 214 for quick identification. Examples of starter mechanisms 212 can include tapes (e.g., polyester-based tapes), string, and plastic. Commercially available starter mechanisms can include fishing line, dental floss (comprising, e.g., thin nylon filaments or a ribbon made of a plastic such as polyethylene or Teflon), automobile pinstriping tape, and Linered Removable Acrylic Tape (#S922) available from Specialty Tapes of Franksville, Wis. In some embodiments, for example, the starter mechanism 212 is an adhesive-backed tape that is about 6 mm wide and about 4.5 mil thick.

In some embodiments, the starter mechanism 212 is a material that is applied in liquid form. For example, liquid having a composition similar to that used for the peelable layer 208 can be used as a liquid startermechanism 212. Suitably, a composition for a liquid starter mechanism when dried and/or cured produces a layer of material that is stronger than the peelable layer 208 with which it is used. As with the peelable layer composition, a composition for a liquid-based starter mechanism 212 can be applied using a number of methods, for example by.spraying, spreading, rolling, brushing, or mopping. The method used can depend on factors such as the viscosity and other properties of the liquid starter mechanism composition, as well as the flooring surface and the desired width and appearance of the applied starter mechanism 212.

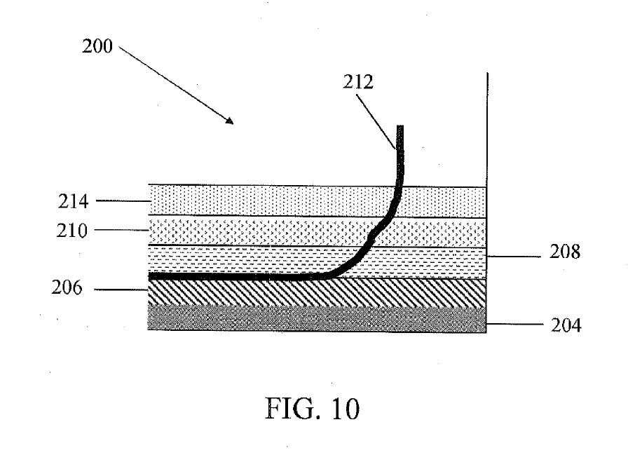

In some embodiments, the starter mechanism 212 is applied to at least a portion of the base layer 206 prior to the addition of the maintenance layer 210. In the embodiment shown in FIG. 3A, the starter mechanism 212 comprises two strips of tape applied along opposite edges of the base layer 206. However, it will be understood that the starter mechanism 212 can be made from a variety of different materials, can have a variety of shapes and sizes, and can be applied in one or more places on the base layer 206. The peelable layer 208 can be applied to the starter mechanism 212 and the base layer 206, as shown in FIG. 3A. Optionally, one or more conventional floor finishes 214 can be applied to the peelable layer 208. In some embodiments of the present invention, a piece of the starter mechanism 212 is exposed above the surface coating system 200 to create a starter strip (see FIG. 10). Alternatively, the entire starter mechanism 212 can be covered by the peelable layer 208.

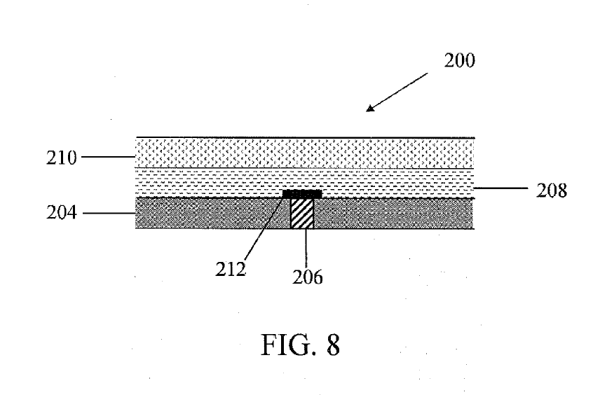

In certain embodiments in which the peelable layer 8 is applied directly onto the upper surface 4 of a flooring substrate, the starter mechanism 212 can be applied in any location upon the flooring substrate. For example, starter mechanisms 212 can be applied onto the joints between sections of the flooring substrate to provide a continuous, smooth surface onto which the peelable layer 208 may be applied, and also to provide a starter mechanism 212 for later removal of the peelable layer 208 (FIG. 8).

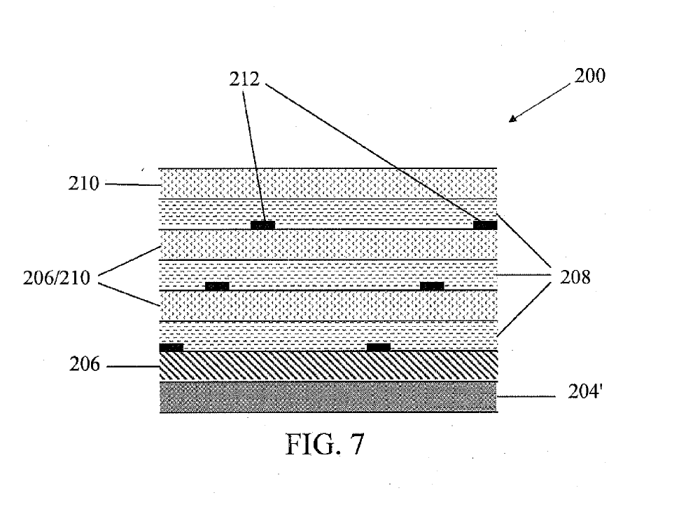

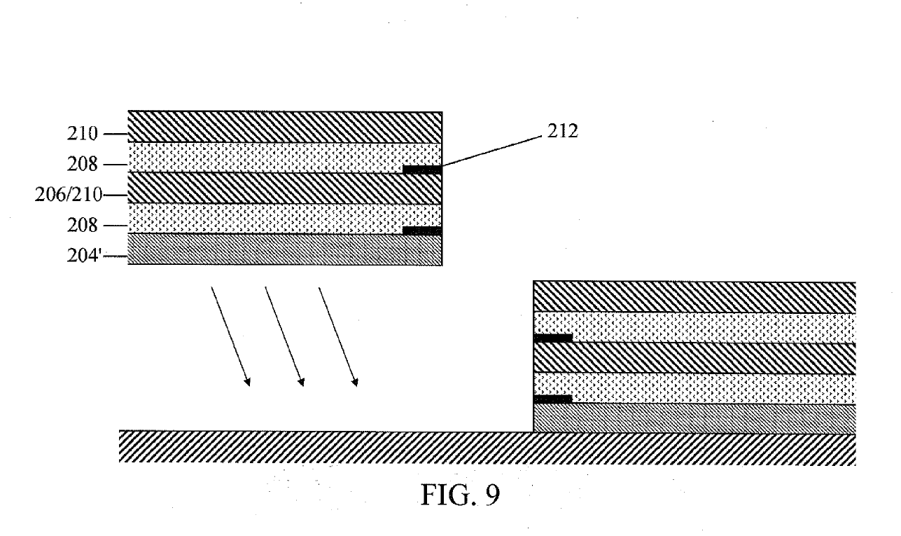

In some embodiments, one or more layers of the surface coating system 200 are applied to an installable flooring substrate 204′ (e.g. tiles or sheet materials) during the manufacture thereof (FIGS. 7, 9). Thus, after the flooring substrate has been installed, its surface can be renewed by removing the topmost layer of the surface coating system 200. This can be repeated for as many layers as have been factory-applied to the substrate. In some embodiments, the starter mechanism 212 of each layer is offset, or staggered, from the starter mechanism 212 of one or more nearby layers in order to prevent a possible buildup of layered materials that could distort the surface (FIG. 7). In some embodiments, starter mechanisms 212 can be applied at least at the edges of the manufactured flooring substrate (FIG. 9).

To remove the peelable layer 208 and the layers thereon, the starter mechanism 212 is pulled through the top layers (i.e., the peelable layer 208, the maintenance layer 210 and, optionally, any conventional floor finishes 214) to create a defined edge that can be used to peel the peelable layer 208 from the underlying base layer 206 as described above. The starter mechanism 212 can be accessed by way of a starter strip, which can be exposed above the various layers, or by cutting through the top layers 208, 210 to reach an embedded starter strip 212.

In other embodiments, the surface coating system 2 is applied to surfaces other than floors, including, for example, other substantially horizontal surfaces, such as surgical tables, food preparation surfaces, desks, tables, as well as vertical surfaces, such as walls, windows, and the like, as well as irregular surfaces, such as food preparation equipment, vessels, tanks, parts, and the like, to name but a few possible uses.

It should be understood that there may be one or more additional layers between the layers described above. In this manner, the layers may be applied directly or indirectly to one another.

### EXAMPLES

The following examples are provided to assist in further understanding of the invention. The particular materials and methods employed are considered to be illustrative of the invention and are not meant to be limiting on the scope of the claims.

### Example 1

### INSTRON™ and POSITEST™ Testing

The testing was done using a version ASTM D 6862-03 “Standard Test Method for 90 Degree Peel Resistance of Adhesives”. The peelable coatings were tested using an INSTRON™ Table Top Electromechanical Single Column Testing System, model 3345 (INSTRON™, Norwood Mass.) using a 90° peeling attachment. The testing was done using a version of ASTM D882-10 “Standard Test Method for Tensile Properties of Thin Plastic Sheeting”. The films were tested using an INSTRON™ Table Top Electromechanical Single Column Testing System, model 3345 (INSTRON™, Norwood Mass.). The testing was done using a version ASTM D4541 “Standard Test Method for. Pull-Off Strength of Coatings Using Portable Adhesion Testers”. The coatings were tested using a POSITEST™ AT manual portable testing (DeFelsko Corporation, Ogdensburg, N.Y.).

Vinyl composite tiles (EXCELON brand, Armstrong Flooring, Lancaster, Pa.) were prepared by applying commercially-available floor finish (OVER & UNDER, Diversey, Sturtevant, Wis.) as a base layer at a rate of 2,000 sq.ft/gal, and allowed to dry.

Next, the peelable layer composition described below was applied at a rate of approximately 300 ft²/gal atop the base layer, and allowed to dry.

| Amount (wt %) | Peelable Layer Component |
|---|---|
| 23.09 wt % | D.I. Water |
| 0.77 wt % | DE Solvent from Dow |
| 0.03 wt % | Zonyl FSJ wetting aid from DuPont |
| 0.15 wt % | Ammonia neutralizing agent from Aldrich |
| 75.0 wt % | Vinnapas EZ222 polymer dispersion from Wacker |
| 0.05 wt % | Robertet 98Mask fragrance from Robertet |
| 0.5 wt % | Proxel GXL preservative from Arch Chemical |
| 0.03 wt % | BYk 024 defoamer from Byk Chemie |

After the coating system had fully cured in air, the tile was then cut into 1 inch sections. Free films were placed into the INSTRON™ Testing System for tensile and elongation analysis. The samples were extended at a rate of 30 mm/min to measure the tensile properties. Tiles were placed in the INSTRON™ Testing System utilizing the 90 degree peel apparatus and the samples were peeled at a rate of 1,000mm/min to measure the peel properties. The software program of the INSTRON™ then automatically calculated the tensile strength, elongation, and peel strength of the sample. Samples were prepared for adhesion testing able adhering stub using 2-part epoxy glue and drying at dry temperature for minimum of 12 hours. POSITEST™ AT tester was used to pull the studs and results are shown in the Table 1.

TABLE 1
Properties of Peelable Layer comprising Base Layer + Peelable Layer
(measured at 20% RH, 70° F.)

| Property | Value (units) |
|---|---|
| Tensile Strength at Max. load (average | 390.9 psi |
| load/area) for Peelable Layer | |
| % Elongation at Break for Peelable | 276.4% |
| Layer | |
| Adhesion Strength (average load/ | 209 psi |
| width) of Peelable Layer to Base Coat | |
| Peel Strength (average load/width) | 424.6 gf/25 mm |

### Example 2

### INSTRON™ Testing

The testing was done using a version ASTM D 6862-03 “Standard Test Method for 90 Degree Peel Resistance of Adhesives”. The peelable coatings were tested using an INSTRON™ Table Top Electromechanical Single Column Testing System, model 3345 (INSTRON™, Norwood Mass.) using a 90° peeling attachment. The testing was done using a version of ASTM D882-10 “Standard Test Method for Tensile Properties of Thin Plastic Sheeting”. The films were tested using an INSTRON™ Table Top Electromechanical Single Column Testing System, model 3345 (INSTRON™, Norwood Mass.).

Vinyl composite tiles (EXCELON brand, Armstrong Flooring, Lancaster, Pa.) were prepared by applying commercially-available floor finish (OVER & UNDER, Diversey, Sturtevant, Wis.) as a base layer at a rate of 2,000 sg.ft/gal, and allowed to dry.

Next, the peelable layer composition described below was applied at a rate of 600 ft²igal atop the base layer, and allowed to dry.

| Amount (wt %) | Peelable Layer Component |
|---|---|
| 22.2 wt % | D.I. Water |
| 1.5 wt % | DE Solvent from Dow |
| 0.03 wt % | Zonyl FSJ wetting aid from DuPont |
| 0.63 wt % | Ammonia neutralizing agent from Aldrich |
| 65.5 wt % | Vinnapas EZ222 polymer dispersion from Wacker |
| 10.5 wt % | Vycar 0823 polymer dispersion from Lubrizol |
| 0.15 wt % | Acticide MBS preservative from Thor |
| 0.03 wt % | BYk 024 defoamer from Byk Chemie |

Two successive layers of the maintenance composition described below were then applied to the peelable layer at a rate of 600 ft²/gal, with a drying period between successive layers of maintenance layer compositions.

| Amount (wt %) | Maintenance Layer Component |
|---|---|
| 36.1 wt % | D.I. Water |
| 55 wt % | NeoCryl 9045 from DSM NeoResins |
| 8 wt % | DPnB Solvent from Dow |
| 0.3 wt % | Byk 028 Defoamer from Byk Chemie |
| 0.3 wt % | Ammonia neutralizing from Aldrich |
| 0.3 wt % | Surfynol 104DPM wetting aid from Air Products |

After the coating system had fully cured in air, the tile was then cut into 1 inch sections. Free films were placed into the INSTRON™ Testing System for tensile and elongation analysis. The samples were extended at a rate of 30 mm/min to measure the tensile properties. Tiles were placed in the INSTRON™ Testing System utilizing the 90 degree peel apparatus and the samples were peeled at a rate of 1000 mm/min to measure the peel properties. The software program of the INSTRON™ then automatically calculated the tensile strength, elongation, and peel strength of the sample are shown in the Table 2.

TABLE 2
Properties of coating comprising Base Layer + Peelable Layer +
Maintenance Layer × 2 (measured at 65° F., 30% RH)

| Property | Value (units) |
|---|---|
| Tensile Strength at Max. load (average load/ | 2,360 psi |
| area) for Peelable Layer + Maintenance | |
| Layer | |
| % Elongation at Break for Peelable Layer + | 84% |
| Maintenance Layer | |
| Peel Strength (average load/width) to peel | 54.8 (grams force/25 mm) |
| Peelable Layer + Maintenance Layer from | |
| Base coat | |

1. A coating system comprising:
a peelable layer composition comprising a peelable layer film former; and a maintenance layer composition comprising a maintenance layer film former having a first Tg from about −100° C. to about 20° C.

2. The coating system of claim 1, wherein the maintenance layer composition comprises a maintenance layer film former having a first Tg from about −50° C. to about −20° C.

3. The coating system of claim 1, wherein the maintenance layer composition comprises a maintenance layer film former having a second Tg from about −20° C. to about 120° C.

4. The coating system of claim 3, wherein the second Tg is from about 40° C. to about 100° C.

5. The coating system of claim 1, wherein the peelable layer composition has a Tg from about −20° C. to about 60° C.

6. The coating system of claim 1, wherein the peelable layer composition or the maintenance layer composition is a liquid.

7. The coating system of claim 1, wherein the peelable layer film former comprises an ethylene vinyl acetate copolymer or a vinyl acetate acrylate copolymer.

8. The coating system of claim 7, wherein the vinyl acetate acrylate copolymer comprises vinyl acetate-butyl acrylate-methyl methacrylate.

9. The coating system of claim 1, wherein the maintenance layer film former comprises a polyurethane.

10. The coating system of claim 9, wherein the polyurethane comprises a self- crosslinking polyurethane.

11. The coating system of claim 9, wherein the polyurethane comprises a polyurethane copolymer.

12. The coating system of claim 1, wherein the peelable layer composition or the maintenance layer composition further comprises at least one additive selected from the group consisting of plasticizers, neutralizers, wetting agents, defoamers, coalescing agents, preservatives, dyes, pigments, fragrances, nanoparticles, optical components and embedded particles.

13. The coating system of claim 1, further comprising a base layer composition comprising a base layer film former.

14. The coating system of claim 13, wherein the base layer film former has a Tg from about −10° C. to about 100° C.

15. The coating system of claim 13, wherein the base layer composition further comprises at least one additive selected from the group consisting of plasticizers, neutralizers, wetting agents, defoamers, coalescing agents, preservatives, dyes, pigments, fragrances, nanoparticles, optical components and embedded particles.

16. The coating system of claim 1, further comprising a transition layer composition comprising a transition layer film former.

17. The coating system of claim 16, wherein the transition layer film former has a Tg from about 20° C. to about 100° C.

18. The coating system of claim 16, wherein the transition layer composition further comprises at least one additive selected from the group consisting of plasticizers, neutralizers, wetting agents, defoamers, coalescing agents, preservatives, dyes, pigments, fragrances, nanoparticles, optical components and embedded particles.

19. The coating system of claim 1, further comprising a removal tool.

20. A method of coating a surface comprising:
applying a peelable layer composition comprising a peelable layer film former to form a peelable layer having a tensile strength that is greater than an adhesive strength; and
applying a maintenance layer composition comprising a maintenance layer film former, the maintenance layer film former comprising a self-crosslinking polyurethane, a polyurethane copolymer, or a combination thereof.

21. The method of claim 20, wherein the peelable layer film former has a Tg from about −20° C. to about 60° C.

22. The method of claim 20, wherein the peelable layer tensile strength is between about 100 psi and about 3,000 psi.

23. The method of claim 20, wherein the peelable layer adhesive strength is between about 50 psi and about 300 psi.

24. The method of claim 20, wherein an elongation at break of the peelable layer is at least about 50%.

25. The method of claim 20, wherein the peelable layer composition or the maintenance layer composition is a liquid.

26. The method of claim 20, wherein the peelable layer composition and the maintenance layer composition form a coating, the coating having a tensile strength between about 100 psi and about 3,000 psi.

27. The method of claim 20, wherein the surface is a floor.

28. A method of coating a surface comprising:
applying a peelable layer composition comprising a peelable layer film former; and
applying a maintenance layer composition comprising a maintenance layer film former, the maintenance layer film having a first Tg from about −100° C. to about 20° C.

29. The method of coating a surface of claim 28, wherein the maintenance layer composition comprises a maintenance layer film former having a first Tg from about −50° C. to about −20° C.

30. The method of coating a surface of claim 29, wherein the maintenance layer composition comprises a maintenance layer film former having a second Tg from about −20° C. to about 120° C.

31. The method of coating a surface of claim 30, wherein the second Tg is from about 40° C. to about 100° C.

32. The method of coating a surface of claim 28, wherein the peelable layer composition has a Tg from about −20° C. to about 60° C.

33. The method of coating a surface of claim 28, wherein the peelable layer composition or the maintenance layer composition is a liquid.

34. The method of coating a surface of claim 28, wherein the peelable layer film former comprises an ethylene vinyl acetate copolymer or a vinyl acetate acrylate copolymer.

35. The method of coating a surface of claim 34, wherein the vinyl acetate acrylate copolymer comprises vinyl acetate-butyl acrylate-methyl methacrylate.

36. The method of coating a surface of claim 28, wherein the maintenance layer film former comprises a polyurethane.

37. The method of coating a surface of claim 36, wherein the polyurethane comprises a self-crosslinking polyurethane.

38. The method of coating a surface of claim 36, wherein the polyurethane comprises a polyurethane copolymer.

39. The method of coating a surface of claim 28, wherein the peelable layer composition or the maintenance layer composition further comprises at least one additive selected from the group consisting of plasticizers, neutralizers, wetting agents, defoamers, coalescing agents, preservatives, dyes, pigments, fragrances, nanoparticles, optical components and embedded particles.

40. The method of coating a surface of claim 28, wherein the surface is a floor.

41. The method of any one of claim 28, wherein the peelable layer composition and the maintenance layer composition form a coating, the coating having a tensile strength between about 100 psi and about 3,000 psi.

42. A coating system comprising:
a peelable layer composition for forming a peelable layer, the peelable layer composition comprising a peelable layer film former and the peelable layer having a tensile strength that is greater than an adhesive strength; and
a maintenance layer composition comprising a maintenance layer film former, the maintenance layer composition comprising a self-crosslinking polyurethane, a polyurethane copolymer, or a combination thereof.

43. The coating system of claim 42, wherein the peelable layer composition or the maintenance layer composition is a liquid.

44. The coating system of claim 42, further comprising a base layer composition comprising a base layer film former.

45. The coating system of claim 42, further comprising a transition layer composition comprising a transition layer film former.

46. The coating system of claim 42, wherein the peelable layer film former has a Tg from about -20° C. to about 60° C.

47. The coating system of claim 42, wherein the tensile strength is between about 100 psi and about 3,000 psi.

48. The coating system of claim 42, wherein the adhesive strength is between about 50 psi and about 300 psi.

49. The coating system of claim 42, wherein an elongation at break of the peelable layer is at least about 50%.

50. The coating system of claim 42, wherein the peelable layer film former comprises at least one of polyacrylate polymers, polyacrylic polymers, epoxy polymers, polystyrene polymers, polyacrylate-styrene copolymer, polyesters, fluoropolymers, polyvinyl chloride, polyvinyl chloride co-vinyl acetate, polyvinyl alcohol, vinyl acetate polymers, vinyl acetate ethylene copolymers, vinyl acetate acrylate copolymers, polyvinylbutyral, styrene-butadiene copolymers, acrylonitrile- butadiene copolymers, and combinations thereof.
